(19) United States
(12) Patent Application Publication
(10) Pub. No.: US 2019/0121620 A1
(43) Pub. Date: Apr. 25, 2019

(54) EXTENSIBLE JAVASCRIPT-BASED DATA VISUALIZATION TOOLKIT

(71) Applicant: Jorge Alarcon, Fairfax, VA (US)

(72) Inventor: Jorge Alarcon, Fairfax, VA (US)

(21) Appl. No.: 16/166,127

(22) Filed: Oct. 21, 2018

Related U.S. Application Data
(60) Provisional application No. 62/575,769, filed on Oct. 23, 2017.

(51) Int. Cl. G06F 8/34; G06F 8/33; G06F 8/30; G06F 16/958; G06T 11/20; G06F 16/9538

(52) U.S. Cl. CPC G06F 8/34; G06F 8/33; G06F 16/9538; G06F 16/958; G06T 11/203; G06F 8/315

(57) ABSTRACT

The disclosure provides an extensible JavaScript-based toolkit that simplifies the programming model to visualize and interact with data natively.

### CROSS-REFERENCE TO RELATED APPLICATIONS

This application claims the benefit of priority under 35 U.S.C § 119(e) to U.S. Provisional Patent Application Ser. No. 62/575,769, titled “CHARTFACTOR—AN EXTENSIBLE JAVASCRIPT-BASED DATA VISUALIZATION TOOLKIT,” filed on Oct. 23, 2017, the disclosure of which is hereby incorporated by reference in its entirety for all purposes.

### FIELD OF THE INVENTION

Embodiments of the present disclosure generally relate to JavaScript-based languages, and more particularly to an extensible JavaScript-based toolkit that simplifies programming model to visualize and interact with data natively.

### BACKGROUND OF THE INVENTION

JavaScript is a high-level, dynamic, weakly typed, object-based, multi-paradigm, and interpreted programming language. Alongside HTML and CSS, JavaScript is one of the three core technologies of World Wide Web content production. It is used to make webpages interactive and provide online programs, including video games. The majority of websites use Javascript, and all modern web browsers support it without the need for plug-ins by means of a built-in JavaScript engine. Each of the many JavaScript engines represent a different implementation of JavaScript, all based on ECMAScript specification, with some engines not supporting the spectrum fully, and with many engines supporting additional features beyond ECMA.

### SUMMARY OF THE INVENTION

The presently disclosed embodiments are directed to solving one or more of the problems presented in the prior art, as well as providing additional features that will become readily apparent by reference to the following detailed description when taken in conjunction with the accompanying drawings.

In an embodiment, the disclosure provides an extensible JavaScript-based toolkit known as “ChartFactor,” which simplifies the implementation of data applications that visualize and interact with data natively. It provides visualization services and query translation services.

The JavaScript-based toolkit includes the following capabilities:

1) Through its visualization services, the JavaScript-based toolkit allows for the addition of data visualizations to web applications, mobile phone, and any device that runs a modern browser.

2) Through its query translation services, the JavaScript-based toolkit interacts natively with data technologies. That is, the JavaScript-based toolkit can query a BI server, data streams, big data, SQL and no-SQL engines directly. The JavaScript-based toolkit can interact with home-grown server APIs because of its extensible Data Provider architecture.

3) The JavaScript-based toolkit provides a programming model that is easy to learn and understand.

4) The JavaScript-based toolkit allows for the configuration of data visualizations in any way to provide rich configuration options to users. The JavaScript-based toolkit can also be extended with other visualizations because of its extensible Aktive Visualizations architecture.

Further features and advantages of the present disclosure, as well as the structure and operation of various embodiments of the present disclosure, are described in detail below with reference to the accompanying drawings.

### BRIEF DESCRIPTION OF THE DRAWINGS

The present disclosure, in accordance with one or more various embodiments, is described in detail with reference to the following figures. The drawings are provided for purposes of illustration only and merely depict exemplary embodiments of the disclosure. These drawings are provided to facilitate the reader's understanding of the disclosure and should not be considered limiting of the breadth, scope, size, or applicability of the disclosure. It should be noted that for clarity and ease of illustration these drawings are not necessarily made to scale.

FIG. 1 provides an illustrative embodiment of the JavaScript-based toolkit at a high level, showing the ability to connect multiple sources straight from the Data Application client;

FIG. 2 provides an illustrative embodiment of the JavaScript-based toolkit components;

FIG. 3 provides an illustrative embodiment of visualizing data using the JavaScript-based toolkit Aktive syntax and Abstractions;

FIG. 4 illustrates an embodiment of a native analytics deployment; and

FIG. 5 illustrates an embodiment of a Native Analytics deployment.

FIG. 6 illustrates an embodiment of users connecting to data by providing connection parameters;

FIG. 7 illustrates an embodiment of how code can be generated after adding a component to the app;

FIG. 8 illustrates an embodiment of an application with several widgets;

FIG. 9 illustrates an embodiment of using a simplified programming model to visualize Top x/Bottom x elements;

FIG. 10 illustrates an embodiment of how stacked bars can be rendered when executing code;

FIG. 11 illustrates an embodiment of how a simplified programming model can be used to visualize pivoted attributes on a pivot table;

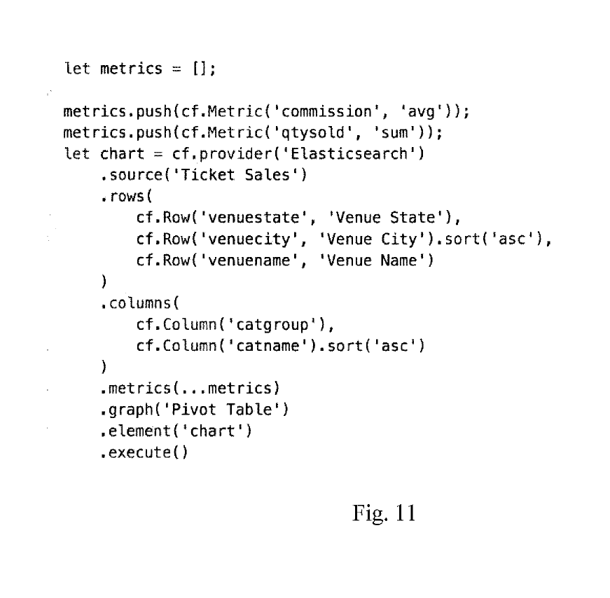

FIG. 12 illustrates an embodiment of a how a pivot table can be rendered when executing code;

FIG. 13 illustrates an embodiment of how a simplified programming model can be used to visualize rows with specific fields of a table;

FIG. 14 illustrates an embodiment of how a raw data table can be rendered when executing code; and

FIG. 15 illustrates an embodiment of the different components of the simplified programming model for data visualizations.

### DETAILED DESCRIPTION OF EXEMPLARY EMBODIMENTS

The following description is presented to enable a person of ordinary skill in the art to make and use embodiments described herein. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the disclosure. Thus, the present disclosure is not intended to be limited to the examples described herein and shown, but is to be accorded the scope consistent with the claims.

The word “exemplary” is used herein to mean “serving as an example illustration.” Any aspect or design described herein as “exemplary” is not necessarily to be construed as preferred or advantageous over other aspects or designs.

It should be understood that the specific order or hierarchy of steps in the process disclosed herein is an example of exemplary approaches. Based upon design preferences, it is understood that the specific order or hierarchy of steps in the processes may be rearranged while remaining within the scope of the present disclosure. Any accompanying method claims present elements of the various steps in a sample order, and are not meant to be limited to the specific order or hierarchy presented.

The disclosure provides a simplified computer-implemented method of creating applications that allow users to visualize data on web browsers and web-enabled devices while aggregating data directly from SQL and no-SQL data systems.

The disclosed systems and methods include an environment where users can connect directly to their data systems and add/remove components to use in their application. These components can be of type visualization or interactivity. Visualization components are statistical charts such as bars, trend lines, and box plots, Interactivity components provide behavior such as filtering and slicing when selecting elements of a visualization component. The underlying code of each of these components can be modified individually to change their behavior.

As described above, each component can be configured through code. The code uses a simplified, declarative programming model that allows users to describe the aggregate or raw queries needed and how results should be visualized, including the type of visualization and any of its properties (e.g. axis, labels, legends, colors).

The disclosed simplified programming model removes the need of explicitly performing asynchronous calls to data systems. The model uses a computational directed acyclic graph (DAG) to save all performed operations for later execution until it performs an action-type statement such as execute( ). This statement triggers the optimization and execution of all operations, including queries to the underlying data system and the rendering of visualizations on a user's device.

The disclosed programming model includes methods to extend data visualizations through modules. These modules can include one visualization or a family of visualizations. These family of visualizations are usually grouped by the external libraries they depend on.

The disclosed programming model also includes methods to extend data providers through modules. This is the way additional data systems can be supported. Although data provider modules run fully on user's devices, they can also run on servers for testing and off-loading purposes. Furthermore, data applications created in the environment described herein can be exported as simple HTML and JavaScript applications.

Accordingly, the embodiments of the present disclosure relate to the extensible JavaScript-based toolkit, which simplifies the programming model to visualize and interact with data natively. The JavaScript-based toolkit provides visualization services and query translation services.

The JavaScript-based toolkit's architecture is designed to be leveraged not only by JavaScript applications but also by applications developed using TypeScript and any other JavaScript-based language that runs on the web browser, typically with a pre-processing step that compiles such language instructions into JavaScript using webpack or similar tools.

In one embodiment, the JavaScript-based toolkit include these capabilities:

1) Through its visualization services, the JavaScript-based toolkit allows for the addition of data visualizations to web applications, mobile phone, and any device that runs a modern browser.

2) Through its query translation services, the JavaScript-based toolkit interact natively with data technologies. That is, the JavaScript-based toolkit can query a BI server, data streams, big data, SQL and no-SQL engines directly. The JavaScript-based toolkit also interacts with home-grown server APIs because of its extensible Data Provider architecture.

3) The JavaScript-based toolkit provides a programming model that is easy to learn and understand.

4) The JavaScript-based toolkit allows configuration of data visualizations in any way so that you can provide rich configuration options to your users. The JavaScript-based toolkit can also be extended with visualizations because of its extensible Visualizations architecture.

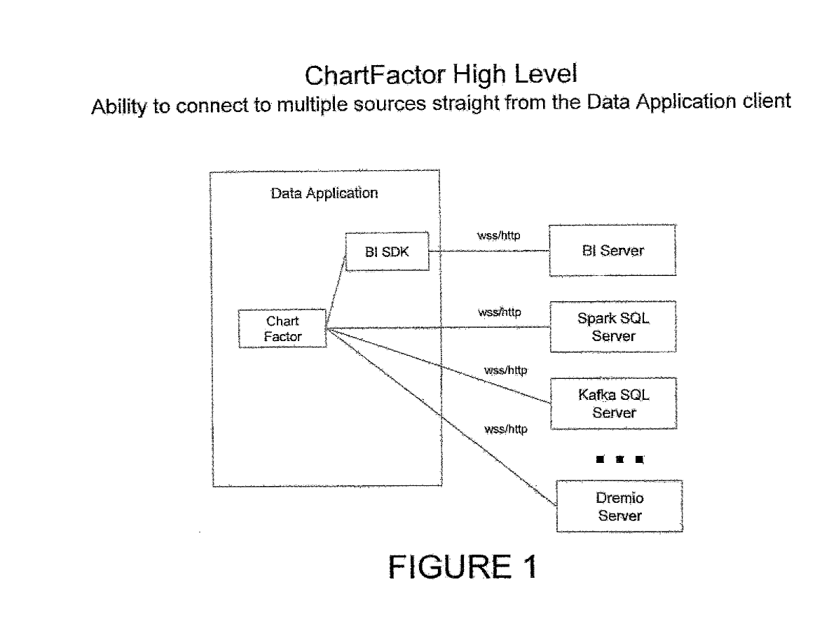

FIG. 1 provides an illustrative embodiment of the JavaScript-based toolkit at a high level, showing the ability to connect multiple sources straight from the Data Application client.

The JavaScript-based toolkit can be used in the following situations:

The JavaScript-based toolkit allows for building interactive data applications and provide rich configuration options to users.

The JavaScript-based toolkit allows for significantly reduced development and testing efforts to build visualizations, query the data, bind results, handle user events, handle errors, format numbers, render labels, render tooltips, render legends, prevent overlaps, and the like.

When a BI server or big data technology is fast enough, the JavaScript-based toolkit allows one to query its data natively.

Through the JavaScript-based toolkit, a data application can leverage an existing security infrastructure. The JavaScript-based toolkit does not implement security. It uses a security token, cookie, and any other authentication/authorization mechanism used by a big data application, technology or service.

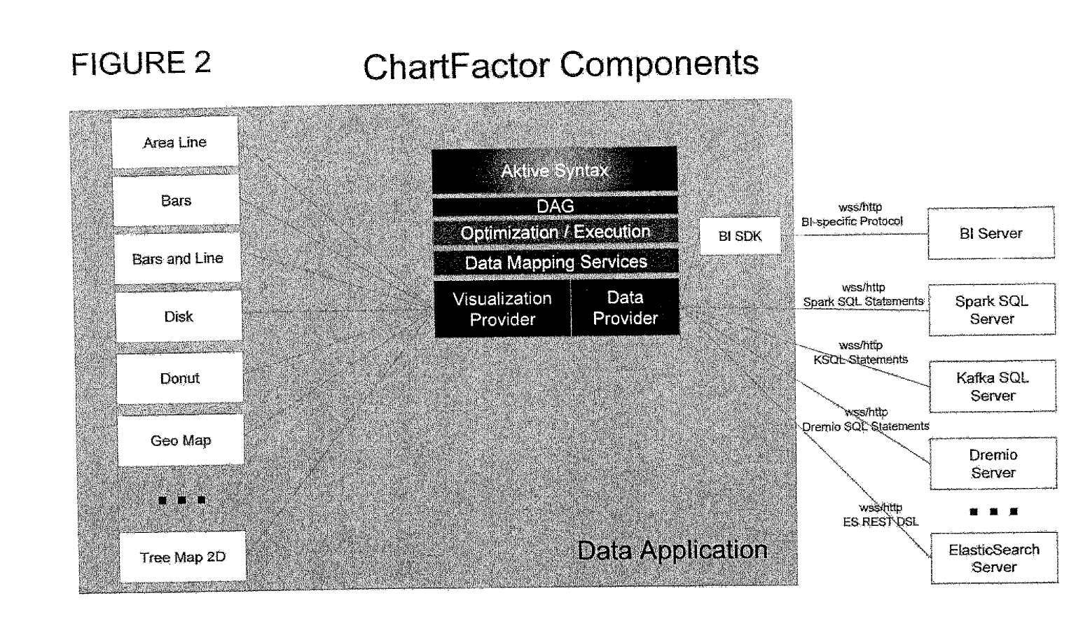

FIG. 2 provides an illustrative embodiment of the JavaScript-based toolkit components.

The JavaScript-based toolkit has two main classes:

1) The Data Provider allows a JavaScript-based application to query data using SQL-like functions we call AQL (Aktiun Query Language). The Data Provider implementation translates them to technology-specific queries.

2) The Visualization API, accessed thru the Aktive driver, allows a JavaScript-based application to easily access chart settings such as labels, legends, tooltips, reference lines, colors, between others.

The JavaScript-based toolkit also includes:

A Provider Spec, a set of functions that can be implemented when creating a Provider implementation. This includes metadata functions to obtain data source lists, field types and labels if available, Currently, we have six Provider implementations: KSQL (Kafka Streaming SQL), Spark SQL, Elasticsearch, Google BigQuery, Dremio, and Zoomdata.

A Visualization Spec, a set of functions that you would implement when extending the JavaScript-based toolkit with other visualizations.

Architecture

The JavaScript-based toolkit provides simple programming model for interactive visualizations that perform aggregations against data systems in real time.

The JavaScript-based toolkit greatly simplifies the programming model of interactive data visualizations through the use of a computation directed acyclic graph (DAG).

The JavaScript-based toolkit programming model allows developers interacting with the toolkit driver to perform functions to retrieve raw and aggregated data and also to render this data in charts, without the need of an async programming model involving promises and performing functions after promises are resolved.

Interactive data visualization involves performing aggregation queries against data systems in an asynchronous way. When the data system responds, a callback or promise resolution function needs to map the data received to specific visualizations' data structures. At this point, the program also needs to perform the mechanics of rendering the visualization in a device display, using the technology available in the appropriate device. For instance, it could use SVG, Canvas, or WebGL when rendering on a web browser.

To simplify this programming model, the JavaScript-based toolkit makes use of a set of functions (Aktive functions) that allows developers to perform all needed data and visualization operations, sync and async, transparently, all at the same time.

The JavaScript-based toolkit includes a provider and visualization interfaces.

The Provider interface (e.g. data provider) includes operations to obtain raw or aggregated data from data systems. These operations are translated to the specific data system query language at execution time. Specific Providers can be plugged-in for different data system technologies.

The Visualization interface exposes visualization-specific operations that affect the shape, size, color, and other characteristics of the chart.

The JavaScript-based toolkit operations can be classified in two types: transformations and actions. On the data provider side, transformations determine how data is grouped, sorted, limited, what metrics are aggregated, what operations are performed for the aggregation. On the visualization side, transformations determine what type of chart is rendered, if legends are displayed, where legends are displayed, if labels are rendered, and many other options.

Transformations in the JavaScript-based toolkit are lazy in that they do not try to execute or obtain results right away. Instead, they just remember the transformations applied. Transformations are executed when an action requires the data to be obtained for the visualization to be rendered.

Actions execute all transformations in an efficient way, including querying the data system, waiting for the data to be returned to the driver program, and rendering visualizations according to previous Aktive commands. The main “action” command in the JavaScript-based toolkit is execute.

The JavaScript-based toolkit simplifies the programming model of interactive data visualizations on a client device through the use of a computation DAG. All JavaScript-based toolkit operations are lazy in that they do not execute right away. Instead, they just remember the transformations applied. These operations include obtaining data from a data system, rendering a chart, displaying chart legends, setting a chart color scheme.

All these operations are executed when an action, most commonly the “execute” action is performed. At this point, all saved operations in the DAG are optimized and executed, including obtaining data from a data system and rendering the visualizations.

The JavaScript-based toolkit allows for the simplification of the programming model of interactive data visualizations on client devices to eliminate the need of explicit asynchronous calls, callback functions, or promise resolutions.

The JavaScript-based toolkit allows for the ability to query data sources natively, straight from the client, instead of having a server in the middle.

The JavaScript-based toolkit allows for the ability to plugin and extend data providers that translate Aktive functions to technology-specific data source queries.

The JavaScript-based toolkit allows for the ability to plugin and extend the toolkit with new visualizations.

The JavaScript-based toolkit allows for the optimized execution of data query, transformations, and visualization functions through the use of a DAG.

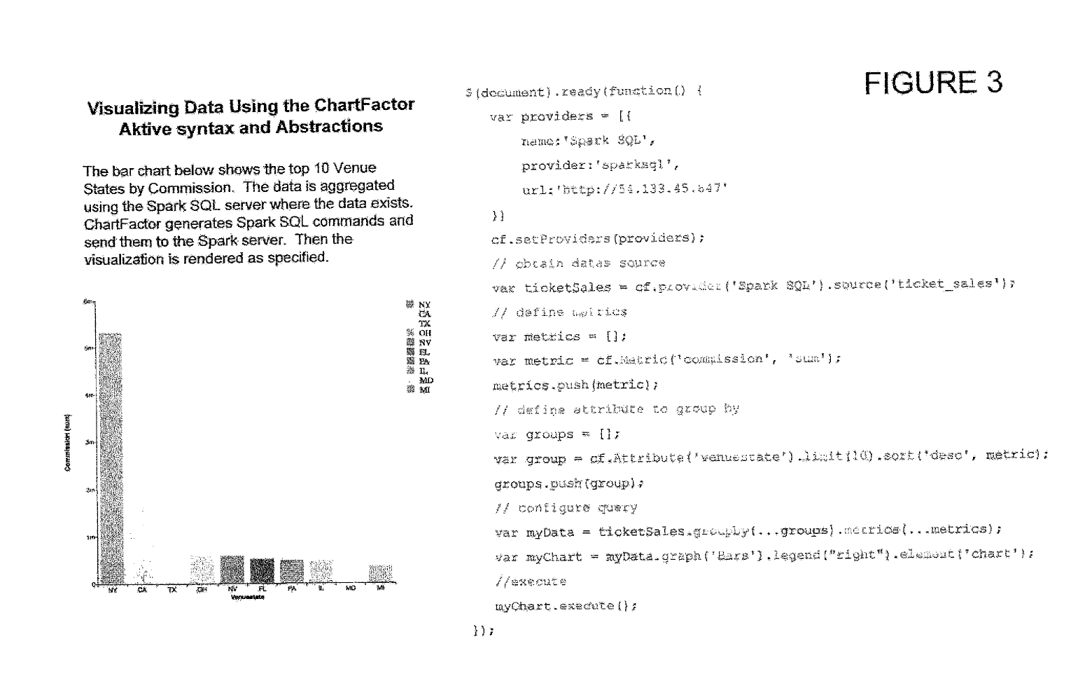

FIG. 3 provides an illustrative embodiment of visualizing data using the JavaScript-based toolkit Aktive syntax and Abstractions.

The JavaScript-based toolkit provides a syntax (Aktive) to perform raw and aggregate queries against data systems and also to visualize the data and define all visualization properties (e.g. axis, labels, legends, colors, etc.).

The JavaScript-based toolkit provides a pluggable data provider to translate the Aktive syntax to technology-specific data query syntax.

The JavaScript-based toolkit provides a pluggable visualization provider to translate the Aktive syntax to technology-specific visualizations.

The JavaScript-based toolkit provides for a computation DAG to save Aktive operations for later execution.

The JavaScript-based toolkit provides for an optimization component to optimize operations in the DAG before execution.

The JavaScript-based toolkit provides for an execution component to perform all operations defined in the DAG.

In the old fashion way, developers perform async calls to retrieve data from a data system. After these async calls are resolved, developers usually provide a callback function or promise resolver to map the received data and to draw the visualization in the device's display using technologies such SVG, Canvas, or WebGL, depending on the visualization and device support for these technologies.

With the JavaScript-based toolkit, developers simply specify how data should be queried and how it should be rendered in the device in a declarative way (as opposed to imperatively). Then, developers invoke the “execute” action to render the final visualization.

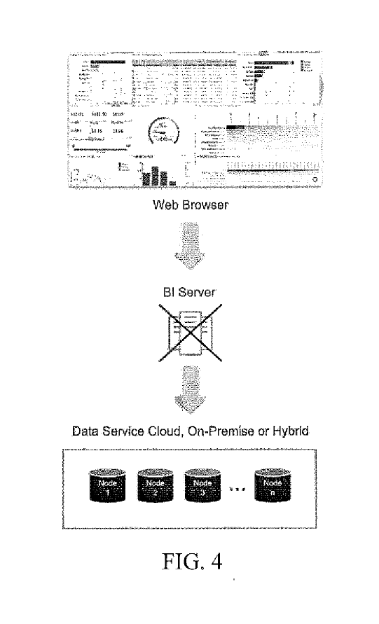

FIG. 4 illustrates an embodiment of a native analytics deployment.

The JavaScript-based toolkit enables querying modern data engines natively and directly from the web browser or web-enabled device. With this capability, the toolkit allows users to perform the same interactive data analysis and discovery as current BI products. However, this powerful and simplified architecture removes the current BI middleware, which translates into many benefits.

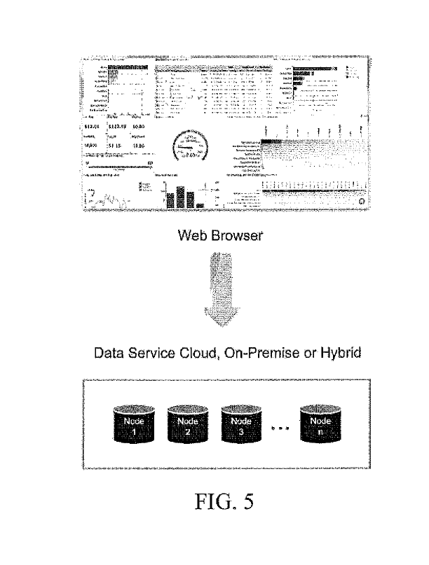

FIG. 5 illustrates an embodiment of a Native Analytics deployment.

The benefits of the JavaScript-based toolkit include:

Leverage of the native security model of the data platform: Current BI deployments bring their own security models, adding administration complexity, performance overhead, and security risks.

Reduced infrastructure costs: Current BI deployments, hosted on the cloud or on premise, require additional hardware many times with high memory requirements.

Fewer Points of Failure: BI servers may fail for multiple reasons, requiring additional hardware for fault-tolerant deployments and adding system administration costs.

Improved Performance: Current BI solutions that interact with modern data may actually slow it down. One example is when a BI server hits policy limits because it connects to the data engine using the same user account for all users. Another example is when the BI server runs scheduled jobs to collect its own statistics. This can also cause stale data problems during data analysis.

No need for single stack or end-to-end BI products.

More interoperable, extensible and embeddable architecture.

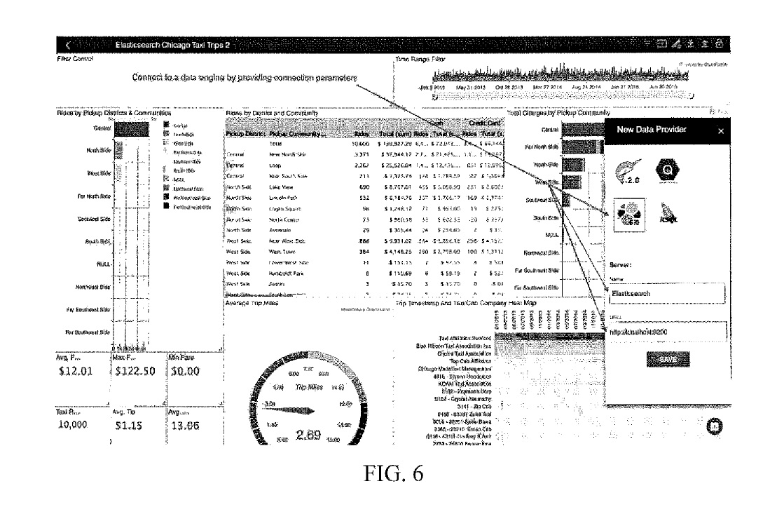

As shown in FIG. 6, users can connect to data by providing connection parameters. Thus, in an embodiment, the disclosure provides a computer-implemented method of creating applications that allow users to visualize data on web browsers and other devices while aggregating and querying data directly from SQL and no-SQL data systems. The computer system allows users to connect to their data systems after they provide network addresses, authentication information, or/and other parameters specific to the data system technology. The computer system also generates code for visualization components users want to incorporate into their data application. The computer system generates code for behavior components users want to incorporate into their data application. Examples of behavior components are filtering and slicing actions triggered by end-users selecting elements of a visualization component. Users can modify the underlying code of each of these components individually to affect their functionality. Users can also position these components where they want them to be in the device screen. Users can export the data application in different formats to be imported by other users. Formats can target a specific runtime environment, device, or a basic HTML/JavaScript application for example. The generated data application allows end-users to visualize aggregate and raw data from the underlying data system without the need of analytics business intelligence servers.

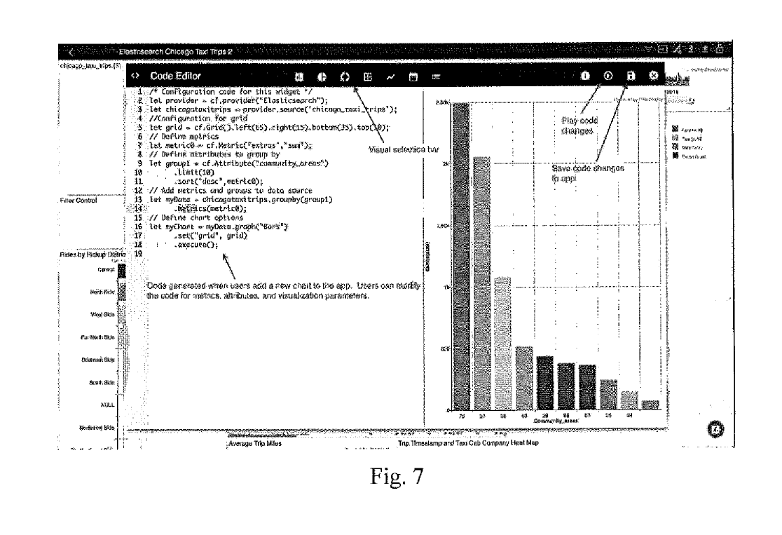

FIG. 7 illustrates an embodiment of how code can be generated after adding a component to the app. Users can select different types of visualizations, change the code, play changes, and saving to the app.

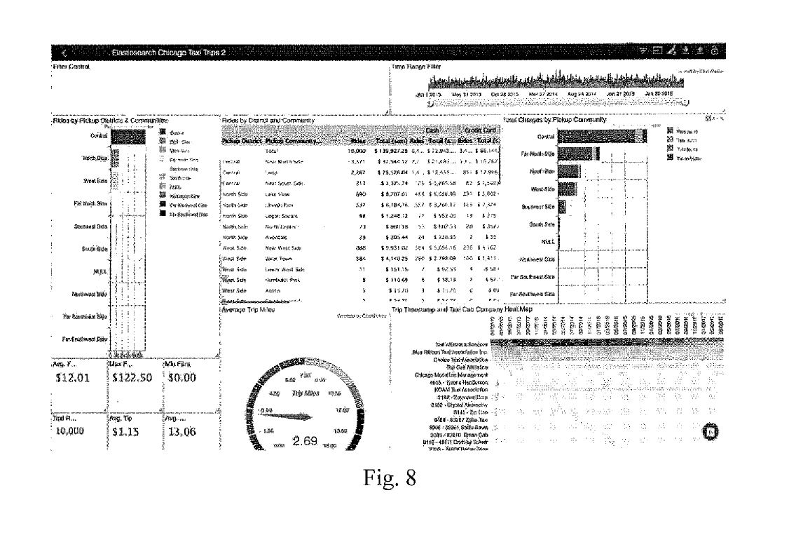

FIG. 8 illustrates an embodiment of an application with several widgets.

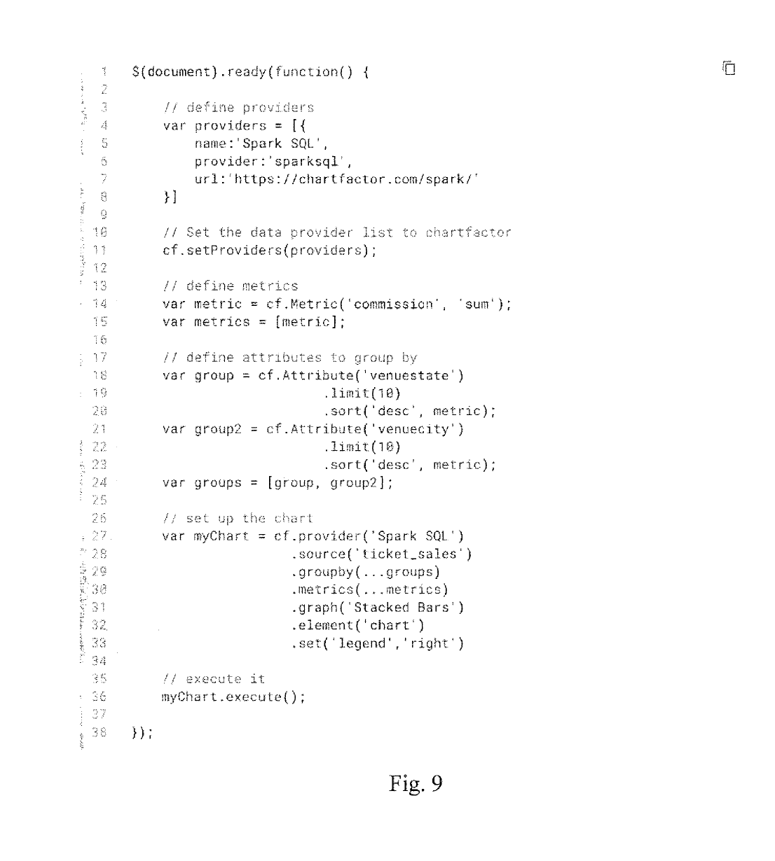

FIG. 9 illustrates an embodiment of the simplified programming model to visualize Top x/Bottom x elements

In another embodiment, the disclosure provides a simplified, declarative programming model for allowing to describe aggregate queries in the numerical form of a “top x,” e.g. a “top 10” or a “bottom y”, e.g. a “bottom 20” and how results should be visualized, including the type of visualization and any of its properties (e.g. axis, labels, legends, colors). the steps to visualize top 10 elements according to a specified aggregation using the simplified declarative programming model include: declaring data systems connection information including network addresses, authentication information, or/and other parameters specific to the data system technology; declaring the source which can be a table, view, or other type of object in the data system; declaring metrics needed together with their aggregate operation (e.g. sum, avg, min, max, distinct); declaring attributes needed, if any, their limit (e.g. 10), and sorting options (e.g. top/bottom); declaring how results should be visualized, including the type of visualization and any of its properties (e.g. axis, labels, legends, colors); executing the above declarations using an action function such as “execute”. All declarations above can use an optional pipe-based syntax where the output of one function flows into the next.

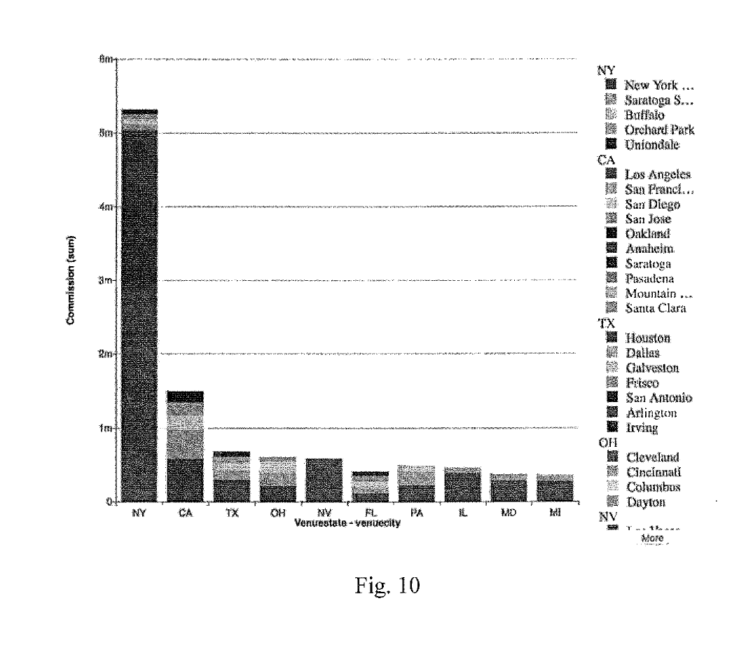

FIG. 10 illustrates an embodiment of stacked bars rendered when executing code.

In another embodiment, the disclosure provides a simplified, declarative programming model for allowing to describe pivot queries and how results should be visualized, including the type of visualization and any of its properties (e.g. table properties, axis, labels, legends, colors). The steps a user would take to visualize a pivot table using the simplified declarative programming model include declaring data systems connection information including network addresses, authentication information, and other parameters specific to the data system technology; declaring the source which can be a table, view, or other type of object in the data system; declaring metrics needed if any together with their aggregate operation (e.g. sum, avg, min, max, distinct); declaring zero or more attributes that will be used in the rows of the pivot table and their sorting options; declaring zero or more attributes that will be used in the columns of the pivot table and their sorting options; declaring how results should be visualized, including the type of visualization and any of its properties (e.g. table, axis, labels, legends, colors); and executing the above declarations using an action function such as “execute.” All of the declarations can use an optional pipe-based syntax where the output of one function flows into the next.

FIG. illustrates an embodiment of using simplified programming model to visualize pivoted attributes on a pivot table.

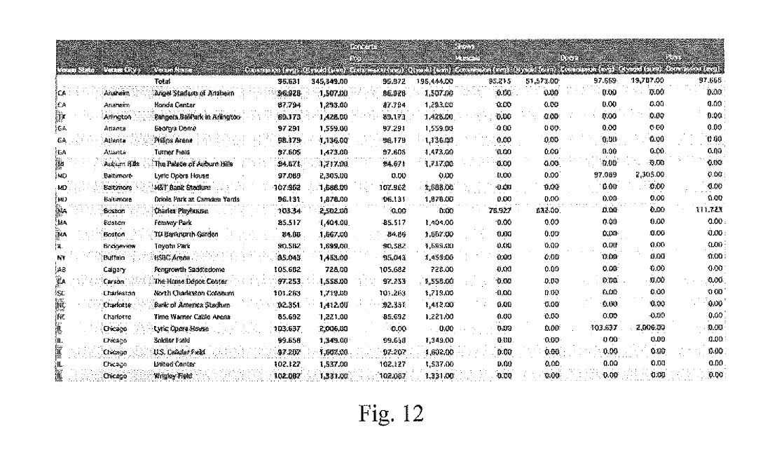

FIG. 12 illustrates an embodiment of how a pivot table can be rendered when executing code.

In another embodiment, the disclosure provides a simplified, declarative programming model for allowing to describe raw data queries and how results should be visualized, including table properties such as labels and colors. The steps a user would take to visualize a raw data table using the simplified declarative programming model include declaring data systems connection information including network addresses, authentication information, and other parameters specific to the data system technology; declaring the source which can be a table, view, or other type of object in the data system; declaring the fields that should be included or excluded in the raw data query (By raw data query we mean the exact records without aggregations); declaring how results should be visualized, including table properties such as column auto-sizing, labels and colors; and executing the above declarations using an action function such as “execute.” All of the declarations above can use an optional pipe-based syntax where the output of one function flows into the next.

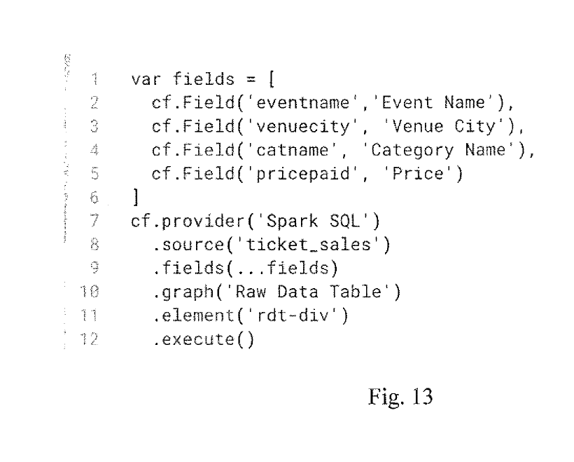

FIG. 13 illustrates an embodiment of using simplified programming model to visualize rows with specific fields of a table.

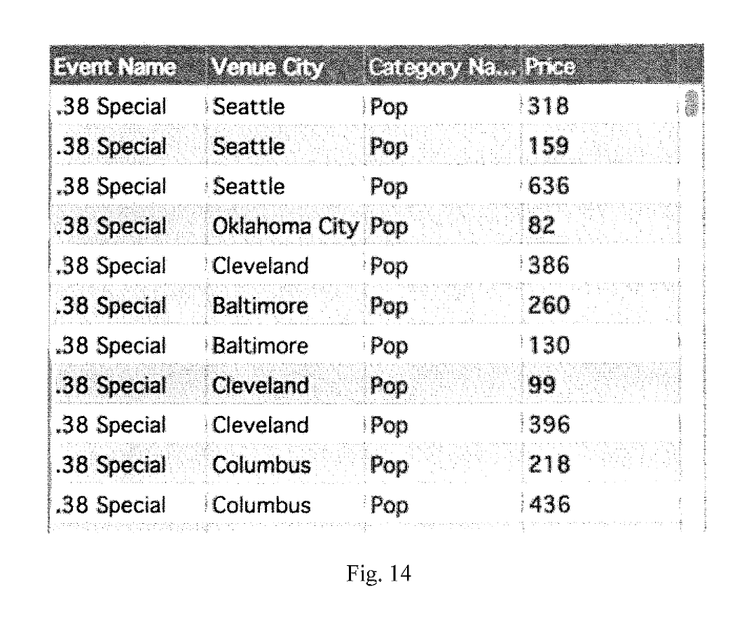

FIG. 14 illustrates an embodiment of how a raw data table can be rendered when executing code.

In another embodiment, the disclosure proves a simplified programming model for removing the need of explicitly performing asynchronous calls to data systems. It uses a computational directed acyclic graph (DAG) to save all performed operations for later execution until it performs an action-type statement such as execute( ). This execute method triggers the optimization and execution of all operations, including queries to the underlying data system and the rendering of visualizations on the user device. The steps a user can take include declaring data systems connection information including network addresses, authentication information, or/and other parameters specific to the data system technology (this information is saved in the DAG); declaring the source which can be a table, view, or other type of object in the data system (this information is saved in the DAG); declaring metrics needed if any together with their aggregate operation (e.g. sum, avg, min, max, distinct) (this information is saved in the DAG); declaring attributes needed if any, their limit, and sorting options (this information is saved in the DAG); declaring how results should be visualized, including the type of visualization and any of its properties (e.g. axis, labels, legends, colors) (this information is saved in the DAG); executing the above declarations using an action function such as “execute”. This action triggers the optimization/execution component to organize the declarations above for optimal execution and finally execute the statements. A statement can be to execute an aggregation query in a remote data system and it can also be to color an area of a geomap depending on metric values received.

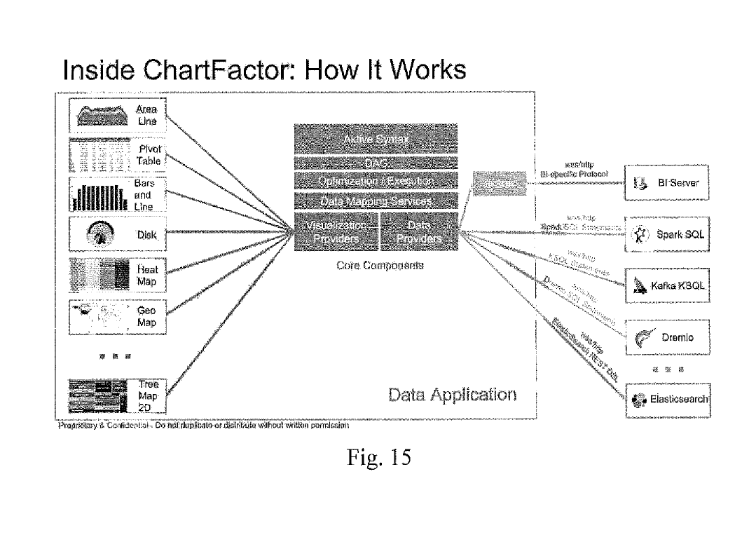

FIG. 15 illustrates an embodiment of the different components of the simplified programming model for data visualizations.

In another embodiment, the disclosure provides methods for extending the base “simplified programming model” to add new visualization modules. Visualization modules group one or more visualizations. They are usually grouped by their dependent libraries although that is not a requirement. The steps include creating a visualization module with the expected function signatures; and deploying the visualization module.

In another embodiment, the disclosure provides methods for extending the base “simplified programming model” to add new data providers to support additional data systems. The data provider translates the statements of the simplified programming model into the specific language of the target data system to query it. These steps include creating a data provider module with the expected function signatures; and deploying the data provider module.

While the inventive features have been particularly shown and described with reference to preferred embodiments thereof, it will be understood by those in the art that the foregoing and other changes may be made therein without departing from the spirit and the scope of the disclosure. Likewise, the various diagrams may depict an example architectural or other configuration for the disclosure, which is done to aid in understanding the features and functionality that can be included in the disclosure. The disclosure is not restricted to the illustrated example architectures or configurations, but can be implemented using a variety of alternative architectures and configurations.

Additionally, although the disclosure is described above in terms of various exemplary embodiments and implementations, it should be understood that the various features and functionality described in one or more of the individual embodiments are not limited in their applicability to the particular embodiment with which they are described. They instead can be applied alone or in some combination, to one or more of the other embodiments of the disclosure, whether or not such embodiments are described, and whether or not such features are presented as being a part of a described embodiment. Thus, the breadth and scope of the present disclosure should not be limited by any of the above-described exemplary embodiments.

What is claimed is:

1. A computer-implemented method for creating applications that allow a user to visualize data on a web browser or web-enabled device, while aggregating and querying data directly from SQL and no-SQL data systems, comprising:
a) connecting to a data system;
b) generating code for visualization and behavioral components to incorporate into the application;
c) independently modifying the generated code for each of the visualization and behavioral components to affect their functionality; and
d) positioning the visualization and behavioral components on a screen of the web browser or web-enabled device, thereby allowing the user to visualize the data.

2. The method of claim 1, wherein connecting to the data system includes providing a network address, authentication information, and/or other parameters specific to the data system.

3. The method of claim 1, wherein the visualization components include statistical charts, bars, trend lines, and/or box plots.

4. The method of claim 1, wherein the behavioral components include filtering and slicing actions triggered by end-users selecting elements of a visualization component.

5. The method of claim 1, wherein the generated code for the visualization and behavioral components can each be modified independently to affect their functionality.

6. The method of claim 1, wherein the application can be exported in different formats to be imported by other users.

7. The method of claim 6, wherein the different formats can target a specific runtime environment, device, or a basic HTML/JavaScript application.

8. The method of claim 1, wherein the application allows an end-user to visualize aggregate and raw data from the data system without the need of an analytics business intelligence server.

9. A computer-implemented method for aggregating and visualizing queries in a numerical form of a “top x” or a “bottom y” using a simplified declarative programming model, comprising:
a) declaring a data system connection information specific to the data system technology;
b) declaring a source object in the data system;
c) declaring metrics together with their aggregate operation;
d) declaring attributes, sorting options, and limits of the form “top x” or “bottom y”;
e) declaring how results should be visualized including the type of visualization and any of its properties including axis, labels, legends, and/or colors; and
f) executing the above declarations using an action function.

10. The method of claim 9, wherein the data system connection information specific to the data system technology includes network addresses, authentication information, and/or other parameters specific to the data system technology.

11. The method of claim 9, wherein the source object is a table, view, or other type of object in the data system.

12. The method of claim 9, wherein the aggregate operations include but is not limited to sum, average, minimum, maximum, count, count distinct, deciles, quartiles, and standard deviation.

13. The method of claim 9, further comprising an optional pipe-based syntax where an output of one function flows into the next.

14. A computer-implemented method for generating a pivot table using a simplified declarative programming model, comprising:
a) declaring a data system connection information including network addresses, authentication information, and other parameters specific the data system technology;
b) declaring a source object, which can be a table, view, or other type of object in the data system;
c) declaring metrics needed if any together with their aggregate operation;
d) declaring zero or more attributes that will be used in the rows of the pivot table and their sorting options;
e) declaring zero or more attributes that will be used in the columns of the pivot table and their sorting options;
f) declaring how results should be visualized, including the type of visualization and any of its properties; and
g) executing the above declarations using an action function.

15. A computer-implemented method for visualizing raw data queries, comprising:
a) declaring data systems connection information including network addresses, authentication information, and other parameters specific to data system technology;
b) declaring a source including a table, view, or other type of object in the data system;
c) declaring fields that are included or excluded in the raw data query of exact records without aggregation;
d) declaring how results should be visualized, including table properties, column auto-sizing, labels and colors;
e) executing the declarations using an action function; and
f) optionally, using an optional pipe-based syntax with the declarations, wherein the output of one function flows into a next function.

16. A computer-implemented method for removing the need of explicitly performing asynchronous calls to data systems, comprising:
a) declaring data, systems connection information including network addresses, authentication information, or/and other parameters specific to the data system technology and saving the data systems connection information in a computational directed acyclic graph (DAG);
b) declaring a source which can be a table, view, or other type of object in the data system and saving source information in a DAG;
c) declaring metrics needed if any together with their aggregate operation including but not limited to sum, average, minimum, maximum, count, count distinct, deciles, quartiles, and a standard deviation, and saving metrics information in a DAG;
d) declaring attributes needed if any, their limit, and sorting options and saving attributes information in a DAG;
e) declaring how results should be visualized, including the type of visualization and any of its properties including axis, labels, legends, colors and saving results information in a DAG; and
f) executing the declarations using an action function.

17. A computer-implemented method for extending a base simplified programming model to add new visualization modules, comprising:
a) creating a visualization module with expected function signatures; and
b) deploying the visualization module.

18. A computer-implemented method for extending a base simplified programming model to add new data providers to support additional data systems, comprising:
a) creating a data provider module with expected function signatures; and
b) deploying the data provider module.
